(19) United States
(12) Patent Application Publication
(10) Pub. No.: US 2015/0113069 A1
(43) Pub. Date: Apr. 23, 2015

(54) MEDIA PLAYING SYSTEM AND MEDIA PLAYING METHOD FOR PLAYING MEDIA FILE IN AREA NETWORK

(71) Applicant: Primax Electronics Ltd., Taipei (TW)

(72) Inventor: JUNG-CHANG YANG, Taipei (TW)

(73) Assignee: Primax Electronics Ltd., Taipei (TW)

(21) Appl. No.: 14/092,459

(22) Filed: Nov. 27, 2013

(30) Foreign Application Priority Data
Oct. 18, 2013 (TW) 102137730

(51) Int. Cl. H04L 29/06

(52) U.S. Cl. CPC H04L 65/403
USPC 709/205

(57) ABSTRACT

A media playing method for playing a media file in an area network is provided. First of all, plural playing devices are assigned to a specified group, and a virtual device corresponding to the specified group is created. When the user wants to simultaneously use the plural playing device to play the media file, the user may simply control the virtual device to play the media file. Consequently, the media file is played by the plural playing devices corresponding to the specified group. Since the media playing method of the present invention is capable of controlling plural playing devices to play the media file by using only a single manual setting procedure, the process of controlling playback of the playing devices is simplified.

### FIELD OF THE INVENTION

The present invention relates to a media playing method, and more particularly to a media playing method for playing a media file in an area network.

### BACKGROUND OF THE INVENTION

Generally, an area network comprises a local area network (LAN), a metropolitan area network (MAN) and a wide area network (WAN). With increasing development of science and technology, the area network further comprises a universal plug and play (UPnP) group and a Digital Living Network Alliance (DLNA). For example, the Digital Living Network Alliance (DLNA) is an alliance organization that is composed by the manufacturers of consumer electronics products, mobile phones and computers. The DLNA is responsible for defining unified transmission specifications to allow a variety of products from different manufacturers to be connected and communicated with each other. Consequently, a first electronic device and a second electronic device that comply with the DLNA protocol can be in direct communication with each other in order to transfer data or make synchronization actions.

First of all, some DLNA architectures will be illustrated as follows. FIG. 1 schematically illustrates a first conventional DLNA architecture. As shown in FIG. 1, the first conventional DLNA architecture 1 comprises a network router 10, a digital media server (DMS) 11, and a digital media player (DMP) 12. The network router 10 is connected to an internet (not shown). In addition, the network router 10 is in communication with the digital media server 11 and the digital media player 12. Consequently, the communication between the digital media server 11 and the digital media player 12 is established through the network router 10. A media file 15 is stored in the digital media server 11. The media file 15 is for example an audio file, an image file or a video file. After the digital media player 12 is in communication with the digital media server 11, the digital media player 12 may search the media file 15 from the digital media server 11. After the media file 15 is selected by the user through the digital media player 12, the media file 15 is transmitted from the digital media server 11 to a temporary memory 121 of the digital media player 12. After the media file 15 is received by the digital media player 12, the media file 15 that is temporarily stored in the temporary memory 121 can be played by the digital media player 12.

FIG. 2 schematically illustrates a second conventional DLNA architecture. As shown in FIG. 2, the second conventional DLNA architecture 2 comprises a network router 20, a digital media server (DMS) 21, and a digital media renderer (DMR) 23. The communication between the digital media server 21 and the digital media renderer 23 is established through the network router 20. The digital media server 21 is used for storing a media file 25. In addition, the digital media server 21 further provides a control function of controlling operations of the digital media renderer 23. The digital media renderer 23 is used for receiving and playing the media file 25 that is transmitted from the digital media server 21. After the control function of the digital media server 21 is utilized to select the stored media file 25 from the digital media server 21, the media file 25 is transmitted from the digital media server 21 to the digital media renderer 23. Consequently, the media file 25 can be played by the digital media renderer 23.

FIG. 3 schematically illustrates a third conventional DLNA architecture. As shown in FIG. 3, the third conventional DLNA architecture 3 comprises a network router 30, a digital media server (DMS) 31, a digital media renderer (DMR) 33, and a digital media controller (DMC) 34. The communication between the digital media server 31, the digital media renderer 33 and the digital media controller 34 is established through the network router 30. The digital media server 31 is used for storing a media file 35. The digital media renderer 33 is used for receiving and playing the media file 35 that is transmitted from the digital media server 31. The digital media controller 34 provides a control function. After the control function of the digital media controller 34 is utilized to select the stored media file 35 from the digital media server 31, the media file 35 is transmitted from the digital media server 31 to the digital media renderer 33. Consequently, the media file 35 can be played by the digital media renderer 33.

As mentioned above, the digital media server, the digital media controller, the digital media renderer and the digital media player that are included in the same network domain and comply with the DLNA protocol may transfer or play media files through the network router. The digital media server and the digital media renderer may be referred as passive electronic devices that can be controlled. Moreover, the digital media controller and the digital media player may be referred as active electronic devices that can control the passive electronic devices. For example, a user in a living room may allow a mobile phone to be connected to a computer host in a study room. Moreover, through the mobile phone, the user may browse the audio files in the computer and select a desired audio file from the computer. Then, the selected audio file is transmitted from the mobile phone to a stereo device in the living room. After the audio file is received by the stereo set, the audio file is played by the stereo device. Consequently, the purposes of conveniently and quickly sharing media contents can be achieved.

Although the DLNA-based media sharing system can provide convenience, the DLNA-based media sharing system still has some drawbacks and is not always user-friendly. For example, in case that plural digital media renderers are included in the same area network and the user controls the plural digital media renderers to play the same media file (e.g. a video file) stored in the digital media server, some drawbacks may occur. For example, if two digital media renderers are included in the same area network, one of the digital media renderers may be located in the living room, and the other digital media renderer may be located in a bedroom. Firstly, the user has to use the digital media controller to operate the first digital media renderer and allow the digital media server to transmit the media file to the first digital media renderer, so that the media file can be played by the first digital media renderer. Next, the above playing operation is performed on the second digital media renderer, so that the media file can be played by the second digital media renderer. Consequently, the user in the living room can view this media file, and another user in the bedroom can also view this media file. In other words, the user has to repeatedly and sequentially perform respective playing operations on all of the plural digital media renderers in order to allow the plural digital media renderers to play the same media file. As known, the way of repeatedly performing the playing operation on different digital media renderers is not user-friendly.

Therefore, there is a need of providing a media playing system and a media playing method for playing a media file in an area network without the need of repeatedly performing the playing operation.

### SUMMARY OF THE INVENTION

The present invention provides a media playing system and a media playing method for playing a media file in an area network without the need of repeatedly performing the playing operation.

In accordance with an aspect of the present invention, there is provided a media playing method for operating a controlling device of an area group to control a first playing device and a second playing device of the area network to play a media file. The media playing method includes the following steps. Firstly, internal connection of the area network is established. Then, the first playing device and the second playing device are assigned to a first group, and a first virtual device corresponding to the first group is created. Then, the first virtual device is added to the area network. Then, a first playing command is transmitted from the controlling device to the first virtual device. Then, the first playing command is transmitted to the first playing device and the second playing device of the first group.

In accordance with another aspect of the present invention, there is provided a media playing system. The media playing system includes a network router, a controlling device, a first playing device, a second playing device, and an assigning module. The network router provides a network connection function. The controlling device is connected to the network router through network connection and issues a first playing command. The first playing device is connected to the controlling device through network connection via the network router and plays a media file in response to the first playing command. The second playing device is connected to the controlling device through network connection via the network router and plays the media file in response to the first playing command. The controlling device, the first playing device and the second playing device are collaboratively defined as an area network. The assigning module assigns the first playing device and the second playing device to a first group, and creates a first virtual device corresponding to the first group, so that the first virtual device is added to the area network. After the first playing command is transmitted from the controlling device to the first virtual device, the first playing command is received by the first playing device and the second playing device of the first group, so that the media file is played by the first playing device and the second playing device.

From the above descriptions, the present invention provides a media playing system and a media playing method for playing a media file in an area network. First of all, plural playing devices are assigned to a specified group, and a virtual device corresponding to the specified group is created. When the user wants to simultaneously use the plural playing device to play the media file, the user may simply control the virtual device to play the media file. Consequently, the media file is played by the plural playing devices corresponding to the specified group. Since the media playing method of the present invention is capable of controlling plural playing devices to play the media file by using only a single manual setting procedure, the process of controlling playback of the playing devices is simplified.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 schematically illustrates a first conventional DLNA architecture;

FIG. 2 schematically illustrates a second conventional DLNA architecture;

FIG. 3 schematically illustrates a third conventional DLNA architecture;

FIG. 4 is a schematic functional block diagram illustrating a media playing system according to a first embodiment of the present invention;

FIG. 5 is a flowchart illustrating a media playing method for playing a media file in an area network according to the first embodiment of the present invention;

FIG. 6 is a flowchart illustrating the step (A) of the media playing method according to the first embodiment of the present invention;

FIGS. 7A and 7B schematically illustrate a first playing device list shown on the controlling device of the media playing system according to the first embodiment of the present invention;

FIGS. 8A-8D schematically illustrate an assigning interface of the media playing system according to the first embodiment of the present invention;

FIG. 9 is a flowchart illustrating the step (C) of the media playing method according to the first embodiment of the present invention;

FIG. 10 is a schematic functional block diagram illustrating a media playing system according to a second embodiment of the present invention;

FIG. 11 is a flowchart illustrating a media playing method for playing a media file in an area network according to the second embodiment of the present invention; and

FIG. 12 is a flowchart illustrating the step (A) of the media playing method according to the second embodiment of the present invention.

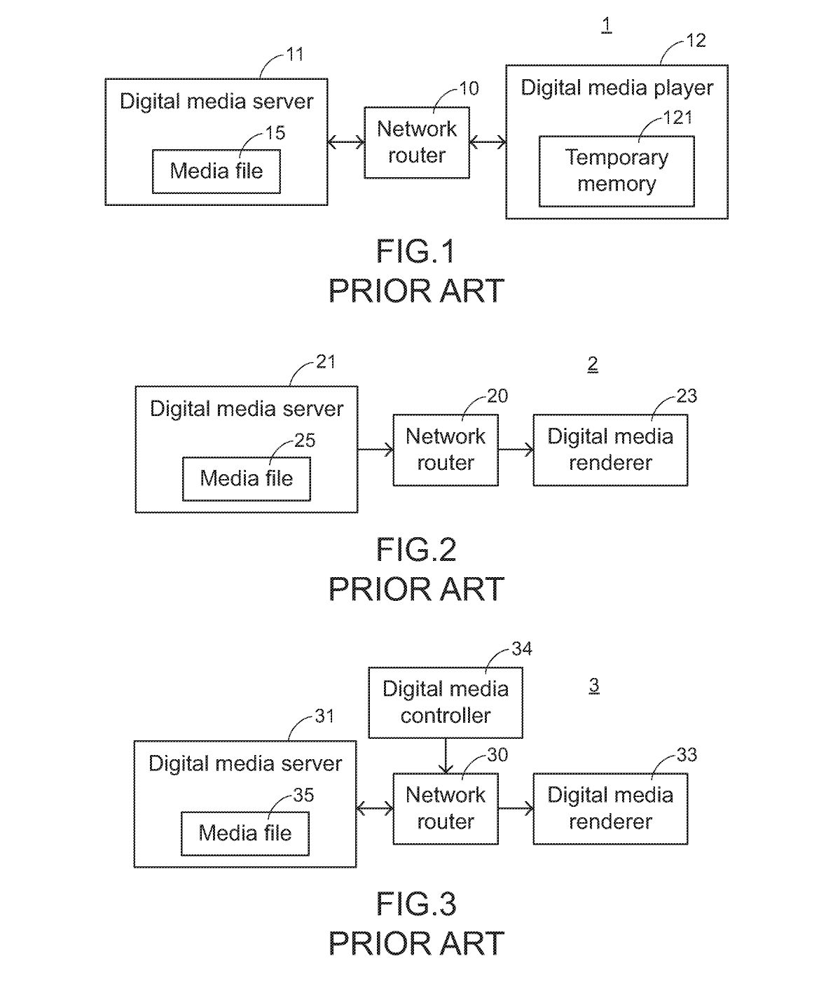

### DETAILED DESCRIPTION OF THE PREFERRED EMBODIMENT

For eliminating the drawbacks of the conventional technology, the present invention provides a media playing method for playing a media file in an area networks and a media playing system for performing the media playing method.

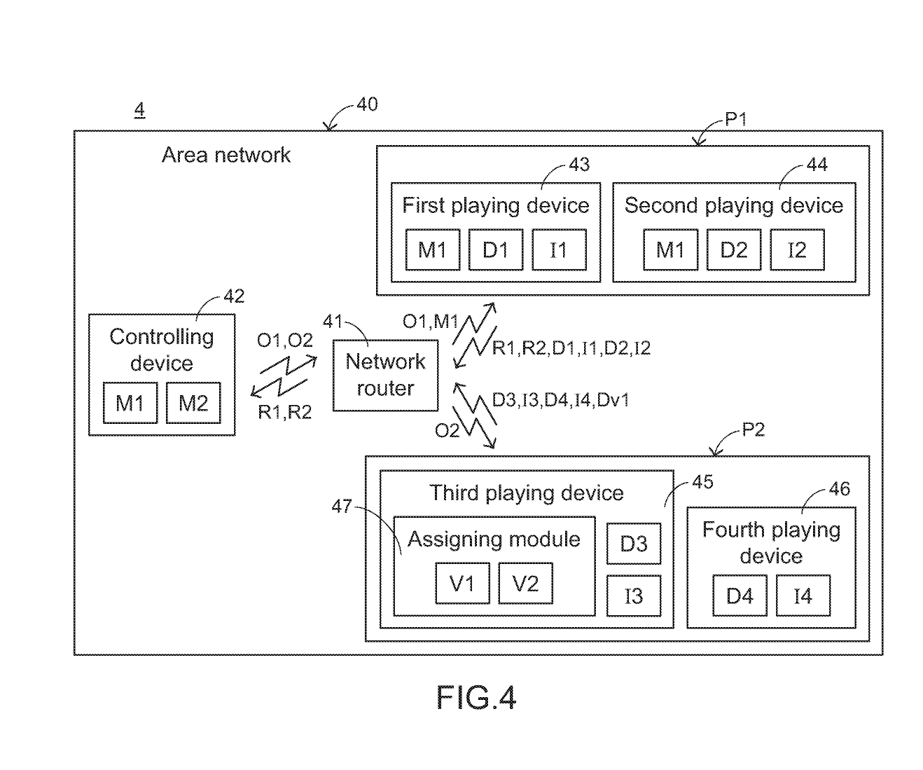

Hereinafter, a media playing system of a first embodiment will be illustrated with reference to FIG. 4. FIG. 4 is a schematic functional block diagram illustrating a media playing system according to a first embodiment of the present invention. As shown in FIG. 4, the media playing system 4 comprises a network router 41, a controlling device 42, a first playing device 43, a second playing device 44, a third playing device 45, a fourth playing device 46, and an assigning module 47. The network router 41 is used to provide a network connection function. Consequently, the controlling device 42, the first playing device 43, the second playing device 44, the third playing device 45 and the fourth playing device 46 are connected with each other through the network router 41. Moreover, the network router 41, the controlling device 42, the first playing device 43, the second playing device 44, the third playing device 45 and the fourth playing device 46 are collaboratively defined as an area network 40. The controlling device 42 is connected to the network router 41 through network connection. In addition, a first media file M1 and a second media file M2 are stored in the controlling device 42. The controlling device 42 is used for playing the first media file M1 and the second media file M2 or issuing a first playing command O1 and a second playing command O2. In this embodiment, the network router 41 complies with the universal plug and play (UPnP) protocol, and the controlling device 42 complies with the Digital Living Network Alliance (DLNA) protocol. In addition, the controlling device 42 is a digital media player.

In the media playing system 4, the first playing device 43 is connected with the controlling device 42 through network connection via the network router 41. Moreover, in response to the first playing command O1, the first playing device 43 plays the first media file M1. The second playing device 44 is connected with the controlling device 42 through network connection via the network router 41. Moreover, in response to the first playing command O1, the second playing device 44 plays the first media file M1. The third playing device 45 is connected with the controlling device 42 through network connection via the network router 41. Moreover, in response to to the second playing command O2, the third playing device 45 plays the second media file M2. The fourth playing device 46 is connected with the controlling device 42 through network connection via the network router 41. Moreover, in response to the second playing command O2, the fourth playing device 46 plays the second media file M2. The assigning module 47 is included in the third playing device 45. In this embodiment, all of the first playing device 43, the second playing device 44, the third playing device 45 and the fourth playing device 46 are digital media renderers. Moreover, both of the first playing device 43 and the second playing device 44 are televisions, the first media file M1 is a video file, both of the third playing device 45 and the fourth playing device 46 are speakers, and the second media file M2 is an audio file.

In this embodiment, the assigning module 47 is a software component included in the third playing device 45, but is not limited thereto. Alternatively, in another embodiment, the assigning module is a hardware component that is individually installed in the area network and connected to other devices of the area network through network connection. Alternatively, in another embodiment, the assigning module is a firmware component included in the first playing device, the second playing device, the fourth playing device or the network router.

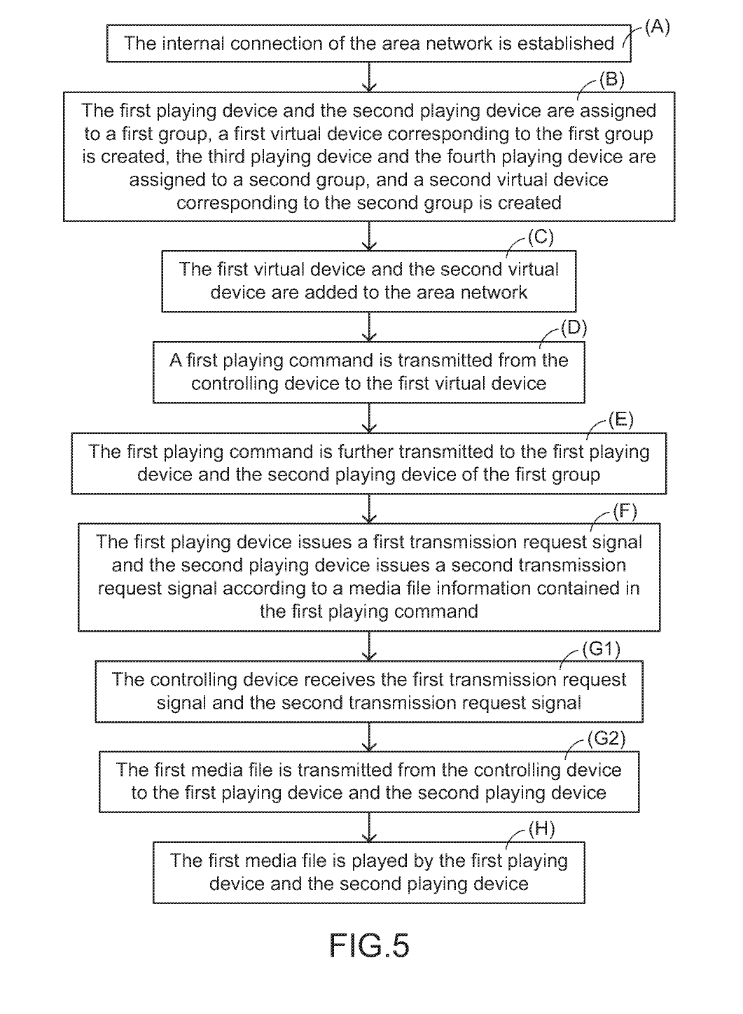

Hereinafter, a media playing method for playing a media file in an area network according to a first embodiment of the present invention will be illustrated with reference to FIG. 5. FIG. 5 is a flowchart illustrating a media playing method for playing a media file in an area network according to a first embodiment of the present invention. The media playing method comprises the following steps. In the step (A), the internal connection of the area network is established. In the step (B), the first playing device and the second playing device are assigned to a first group, a first virtual device corresponding to the first group is created, the third playing device and the fourth playing device are assigned to a second group, and a second virtual device corresponding to the second group is created. In the step (C), the first virtual device and the second virtual device are added to the area network. In the step (D), a first playing command is transmitted from the controlling device to the first virtual device. In the step (E), the first playing command is further transmitted to the first playing device and the second playing device of the first group. In the step (F), the first playing device issues a first transmission request signal and the second playing device issues a second transmission request signal according to a media file information contained in the first playing command. In the step (G1), the first transmission request signal and the second transmission request signal are received by the controlling device. In the step (G2), the first media file is transmitted from the controlling device to the first playing device and the second playing device. In the step (H), the first media file is played by the first playing device and the second playing device.

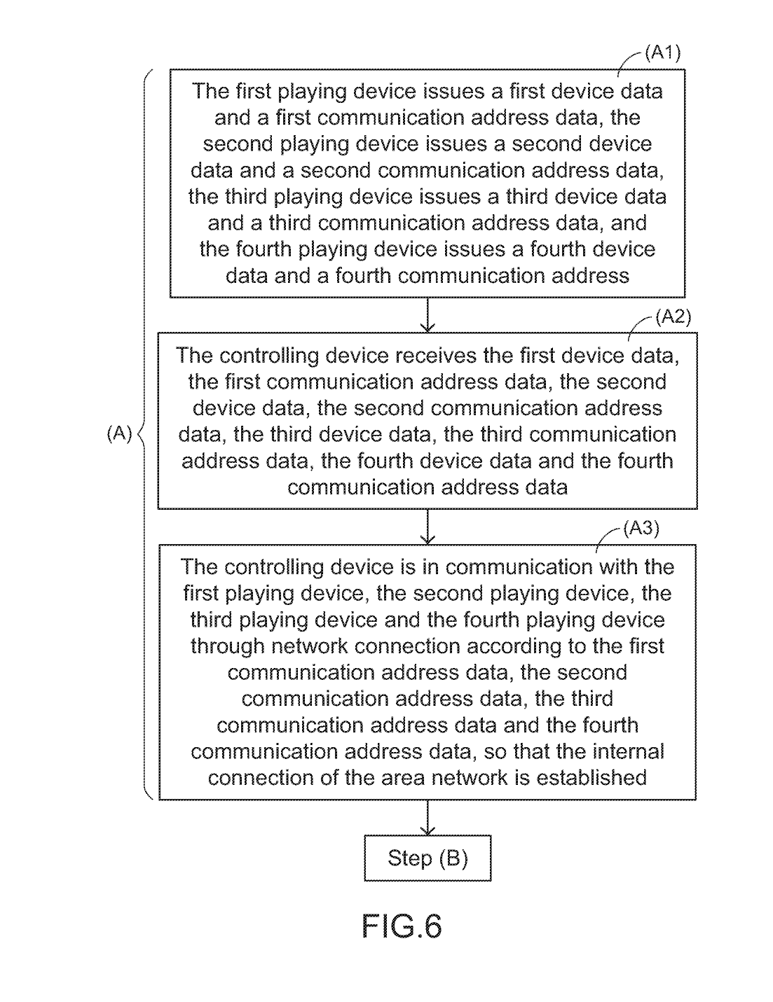

Hereinafter, the detailed procedure of the step (A) performed by the media playing system 4 will be illustrated with reference to FIGS. 4 and 6. FIG. 6 is a flowchart illustrating the step (A) of the media playing method according to the first embodiment of the present invention. The step (A) comprises the following sub-steps. In the sub-step (A1), the first playing device issues a first device data and a first communication address, the second playing device issues a second device data and a second communication address, the third playing device issues a third device data and a third communication address, and the fourth playing device issues a fourth device data and a fourth communication address data. In the sub-step (A2), the controlling device receives the first device data, the first communication address data, the second device data, the second communication address data, the third device data, the third communication address data, the fourth device data and the fourth communication address data. In the sub-step (A3), the controlling device is in communication with the first playing device, the second playing device, the third playing device and the fourth playing device through network connection according to the first communication address data, the second communication address data, the third communication address data and the fourth communication address data, so that the internal connection of the area network is established.

When the sub-step (A1) is performed by the media playing system 4, the first playing device 43 issues the first device data D1 and the first communication address data I1 according to the DLNA protocol. Similarly, the second playing device 44 issues the second device data D2 and the second communication address data I2 according to the DLNA protocol, the third playing device 45 issues the third device data D3 and the third communication address data I3 according to the DLNA protocol, and the fourth playing device 46 issues the fourth device data D4 and the fourth communication address data I4. The first device data D1 contains associated information of the first playing device 43, including the type of the first playing device 43 (e.g. the television of the digital media renderer). Moreover, the first communication address data I1 is an internet protocol address (IP address) of the first playing device 43. Similarly, the second device data D2 contains associated information of the second playing device 44, and the second communication address date I2 is the IP address of the second playing device 44. Similarly, the third device data D3 contains associated information of the third playing device 45, and the third communication address data I3 is the IP address of the third playing device 45. Similarly, the fourth device data D4 contains associated information of the fourth playing device 46, and the fourth communication address data I4 is the IP address of the fourth playing device 46.

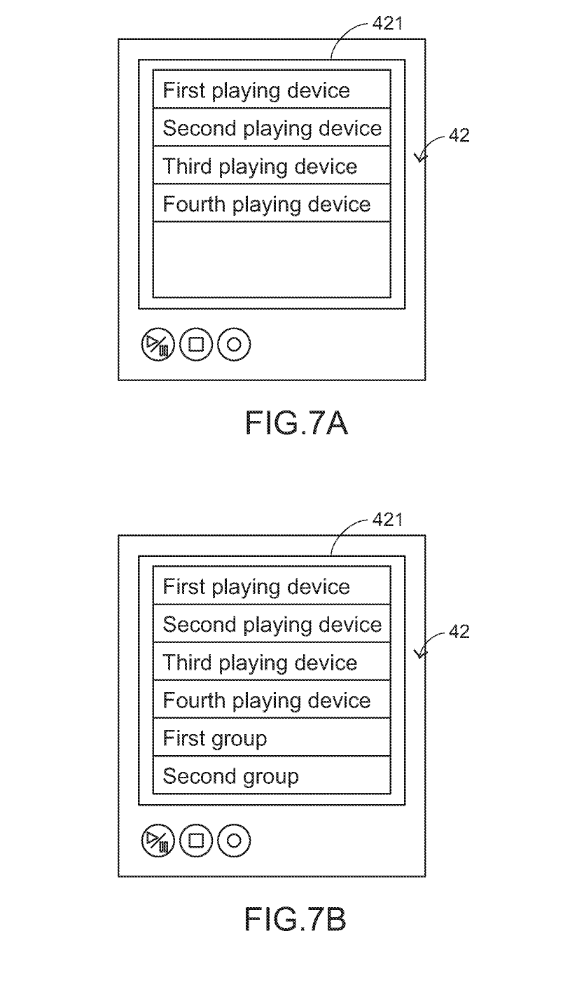

In the sub-step (A2), the controlling device 42 receives the first device data D1, the second device data D2, the third device data D3, the fourth device data D4, the first communication address data IL the second communication address data I2, the third communication address data I3 and the fourth communication address data I4. Consequently, the controlling device 42 can realize the types and the IP address data of the first playing device 43, the second playing device 44, the third playing device 45 and the fourth playing device 46. In the sub-step (A3), the controlling device 42 is in communication with the first playing device 43, the second playing device 44, the third playing device 45 and the fourth playing device 46 through network connection according to the first communication address data I1, the second communication address data I2, the third communication address data I3 and the fourth communication address data I4. Consequently, the internal connection of the area network 40 is established. After the internal connection of the area network 40 is established, a first playing device list 421 shown on the controlling device 42 contains the first playing device 43, the second playing device 44, the third playing device 45 and the fourth playing device 46 (see FIG. 7A). The user may select at least one specified playing device from the first playing device list 421 in order to control the specified playing device to play the first media file M1 or the second media file M2.

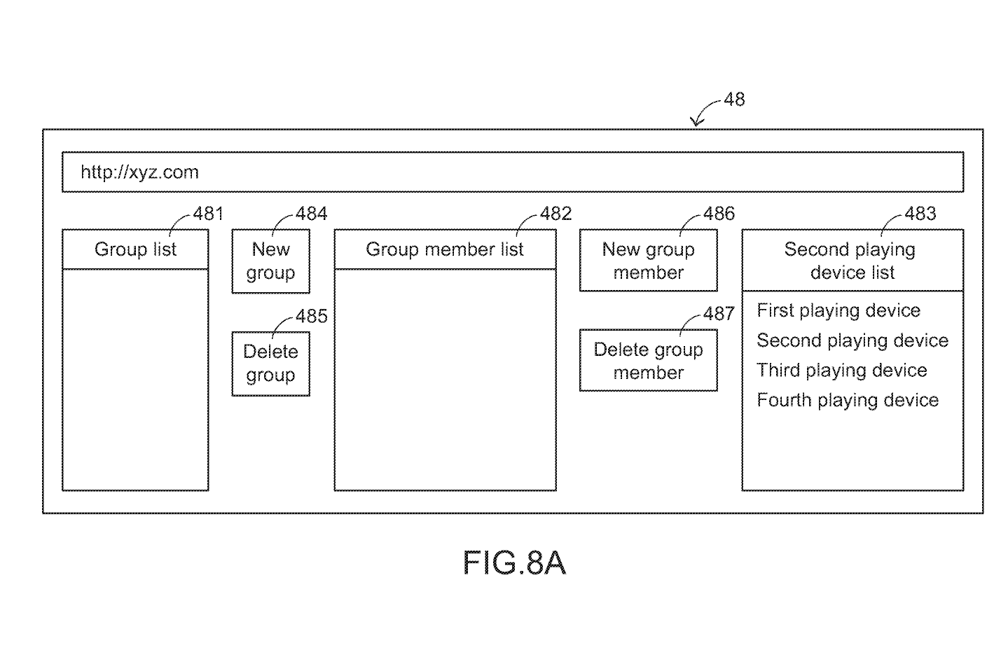

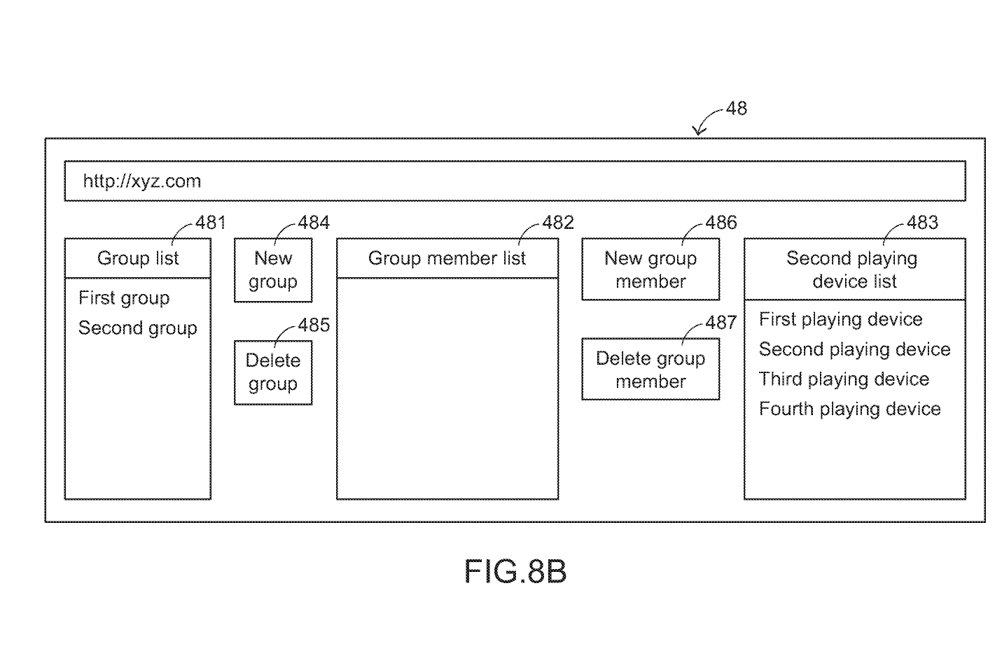

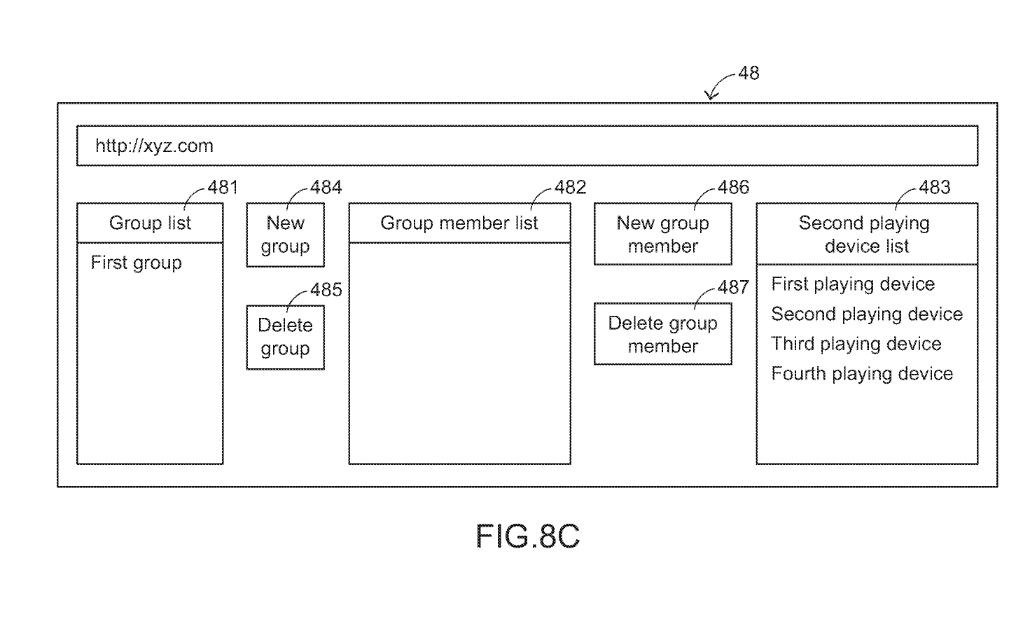

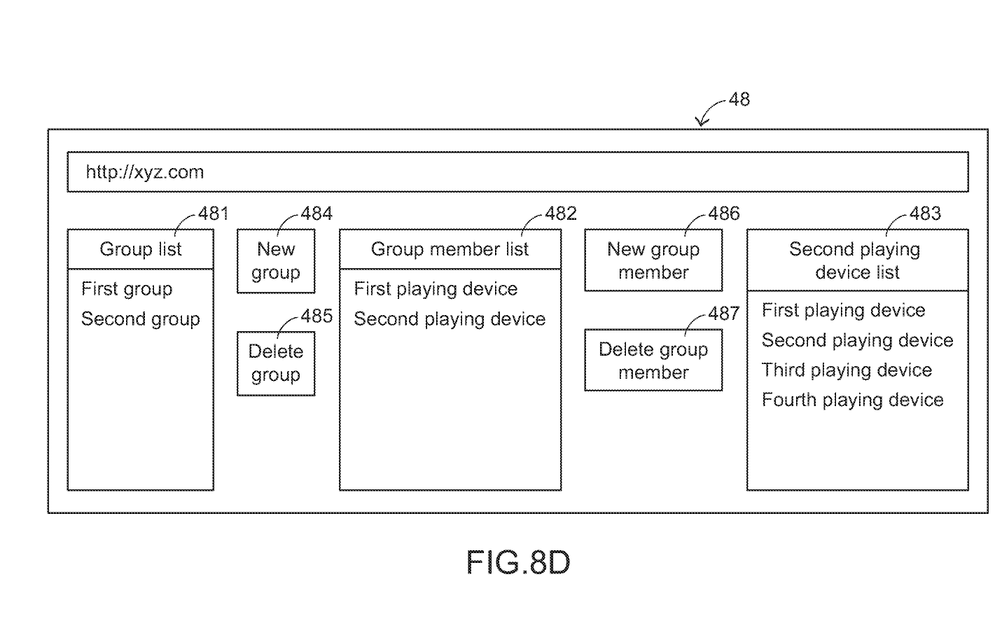

Hereinafter, the detailed procedure of the step (B) performed by the media playing system 4 will be illustrated with reference to FIG. 4 and FIGS. 8A-8D. FIGS. 8A-8D schematically illustrate an assigning interface of the media playing system according to the first embodiment of the present invention. In FIGS. 8A-8D, an assigning interface 48 is shown. The user may operate a third-party device (e.g. a computer) to input a default website address (e.g. http://xyz.com.tw) in order to open an assigning interface 48. The assigning interface 48 comprises a group list 481, a group member list 482, a second playing device list 483, a new group selective item 484, a delete group selective item 485, a new group member selective item 486, and a delete group member selective item 487. The group list 481 is located at a left side of the assigning interface 48. The group list 481 contains a first group P1 and a second group P2 (see FIG. 8B). By clicking the new group selective item 484 (i.e. receiving a group creating command), a new group may be added to the group list 481. Originally, the group list 481 is blank (see FIG. 8A). By clicking the new group selective item 484, the first group P1 and the second group P2 may be added to the group list 481 (see FIG. 8B). On the contrary, by clicking the delete group selective item 485, a specified group of the group list 481 may be deleted. For example, after the delete group selective item 485 is clicked, the user may select the second group P2 of the group list 481 in order to remove the second group P2 from the group list 481. Meanwhile, only the first group P1 is shown in the group list 481 (see FIG. 8C). The second playing device list 483 is located at a right side of the assigning interface 48. The second playing device list 483 contains all playing devices of the area network 40 (i.e. the first playing device 43, the second playing device 44, the third playing device 45 and the fourth playing device 46).

The functions and operations of the new group member selective item 486 and the delete group member selective item 487 will be illustrated as follows. When the user intends to assign the first playing device 43, the second playing device 44 to the first group P1, the first group P1 has to be firstly created in the blank group list 481 (see FIG. 8A). That is, by clicking the new group selective item 484, the first group P1 is added to the group list 481 (see FIG. 8C). Then, after the user selects the first group P1 from the group list 481, the user may select the first playing device 43 and the second playing device 44 from the second playing device list 483 and click the new group member selective item 486 (i.e. receive a first device selection command corresponding to the first playing device and a second device selection command corresponding to the second playing device). Consequently, the first playing device 43 and the second playing device 44 are added to the group member list 482 (see FIG. 8D). Meanwhile, the process of assigning the first playing device 43 and the second playing device 44 is completed. Similarly, the process of assigning the third playing device 45 and the fourth playing device 46 to the second group P2 is similar to the process of assigning the first playing device 43 and the second playing device 44 to the first group P1, and is not redundantly described herein. The way of operating the delete group member selective item 487 to delete a specified playing device from a specified group is similar to the way of operating the new group member selective item 486.

In particular, via the assigning interface 48, the assigning module 47 assigns the first playing device 43 and the second playing device 44 to the first group P1, and assigns the third playing device 45 and the fourth playing device 46 to the second group P2 in order to perform the step (B). After the step (B) is completed, the assigning module 47 creates the first virtual device V1 corresponding to the first group P1 and creates the second virtual device V2 corresponding to the second group P2. In addition, the first virtual device V1 and the second virtual device V2 are added to the area network 40.

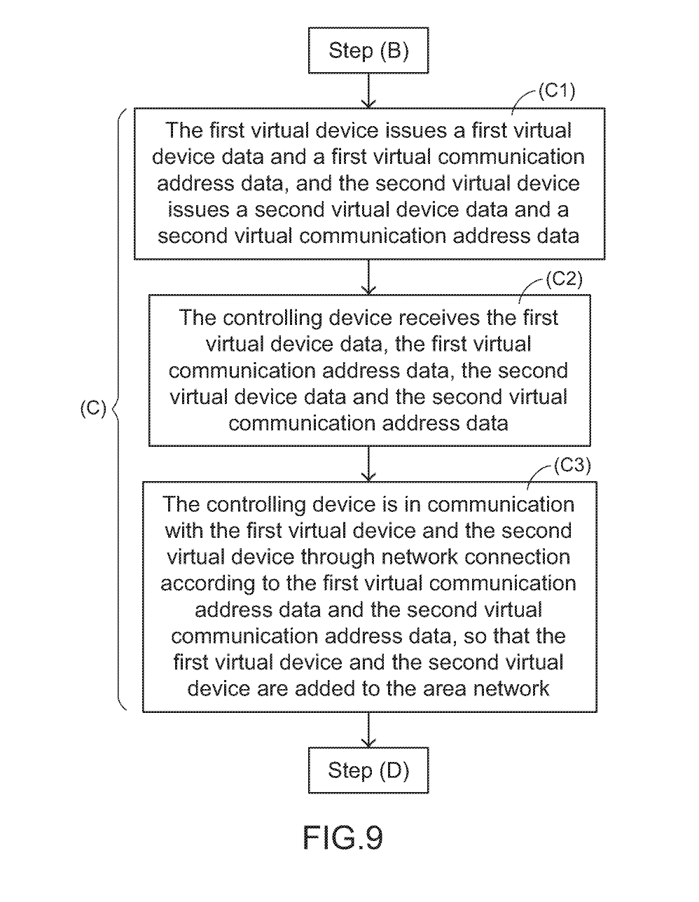

Hereinafter, the detailed procedure of the step (C) performed by the media playing system 4 will be illustrated with reference to FIGS. 4 and 9. FIG. 9 is a flowchart illustrating the step (C) of the media playing method according to the first embodiment of the present invention. The step (C) comprises the following sub-steps. In the sub-step (C1), the first virtual device issues a first virtual device data and a first virtual communication address data, and the second virtual device issues a second virtual device data and a second virtual communication address data. In the sub-step (C2), the controlling device receives the first virtual device data, the first virtual communication address data, the second virtual device data and the second virtual communication address data. In the sub-step (C3), the controlling device is in communication with the first virtual device and the second virtual device through network connection according to the first virtual communication address data and the second virtual communication address data, so that the first virtual device and the second virtual device are added to the area network.

In the sub-step (C1), the contents of the first virtual device data Dv1 are similar to the contents of the first device data D1, the second device data D2, the third device data D3 and the fourth device data D4, and the contents of the first virtual communication address data Iv1 are similar to the contents of the first communication address data I1, the second communication address data I2, the third communication address data I3 and the fourth communication address data I4. Moreover, since the assigning module 47 is included in the third playing device 45, the first virtual communication address data Iv1 from the first virtual device V1 is the third communication address data I3 of the third playing device 45. Likewise, the second virtual communication address data from the second virtual device V2 is the third communication address data I3 of the third playing device 45. The steps (C2) and (C3) are similar to the steps (A2) and (A3), and are not redundantly described herein. It is noted that the first virtual device V1 and the second virtual device V2 are not physical devices.

After the first virtual device V1 and the second virtual device V2 are added to the area network 40, the first playing device list 421 shown on the controlling device 42 contains the first playing device 43, the second playing device 44, the third playing device 45, the fourth playing device 46, the first virtual device V1 and the second virtual device V2. As shown in FIG. 7B, the name of the first virtual device V1 is denoted as “First group P1”, and the second virtual device V2 is denoted as “Second group P2”.

When the user wants to use the first playing device 43 and the second playing device 44 to play the first media file M1 in order to allow the first media file M1 to be viewed by the users at different locations (e.g. different bedrooms), the user may operate the controlling device 42 to select the first media file M1. Then, the user may select the first virtual device V1 from the first playing device list 421. After the first media file M1 and the first virtual device V1 are selected, the first playing command O1 is transmitted from the controlling device 42 to the first virtual device V1. The first playing command O1 contains a first media file information corresponding to the first media file M1. Meanwhile, the step (D) is performed. In this embodiment, the first media file information is a uniform resource locator (URL). After the first playing command O1 is received, the first virtual device V1 can realize the location of the first media file M1 according to the first media file information.

Since the first group P1 comprises the first playing device 43 and the second playing device 44, according to the settings of the media playing system 4, the command or signal that is transmitted to the first virtual device V1 will be transferred to the first playing device 43 and the second playing device 44. Meanwhile, the step (E) is performed. That is, the first playing command O1 is firstly transmitted to the third playing device 45 with the assigning module 47, and then transmitted to the first playing device 43 and the second playing device 44. Next, after the first playing command O1 is received by the first playing device 43, the first playing device 43 realizes that the first media file M1 is stored in the controlling device 42 according to the first media file information. Consequently, the first playing device 43 issues a first transmission request signal R1 to the controlling device 42. On the other hand, after the first playing command O1 is received by the second playing device 44, the second playing device 44 issues a second transmission request signal R2 to the controlling device 42 according to the first media file information. Meanwhile, the step (F) is performed.

In the step (G1), the first transmission request signal R1 from the first playing device 43 and the second transmission request signal R2 from the second playing device 44 are received by the controlling device 42. In response to the first transmission request signal R1 and the second transmission request signal R2, the first media file M1 is transmitted from the controlling device 42 to the first playing device 43 and the second playing device 44 (i.e. the step G2). After the first media file M1 is received by the first playing device 43, the first media file M1 is played by the first playing device 43. In addition, after the first media file M1 is received by the second playing device 44, the first media file M1 is played by the second playing device 44. Meanwhile, the step (H) is performed. The operations of using the third playing device 45 and the fourth playing device 46 to play the second media file M2 are similar to those of using the first playing device 43 and the second playing device 44 to play the first media file M1, and are not redundantly described herein. From the above descriptions, the media playing method of the present invention is capable of allowing plural playing devices to play a media file in an area network by using only a single manual setting procedure.

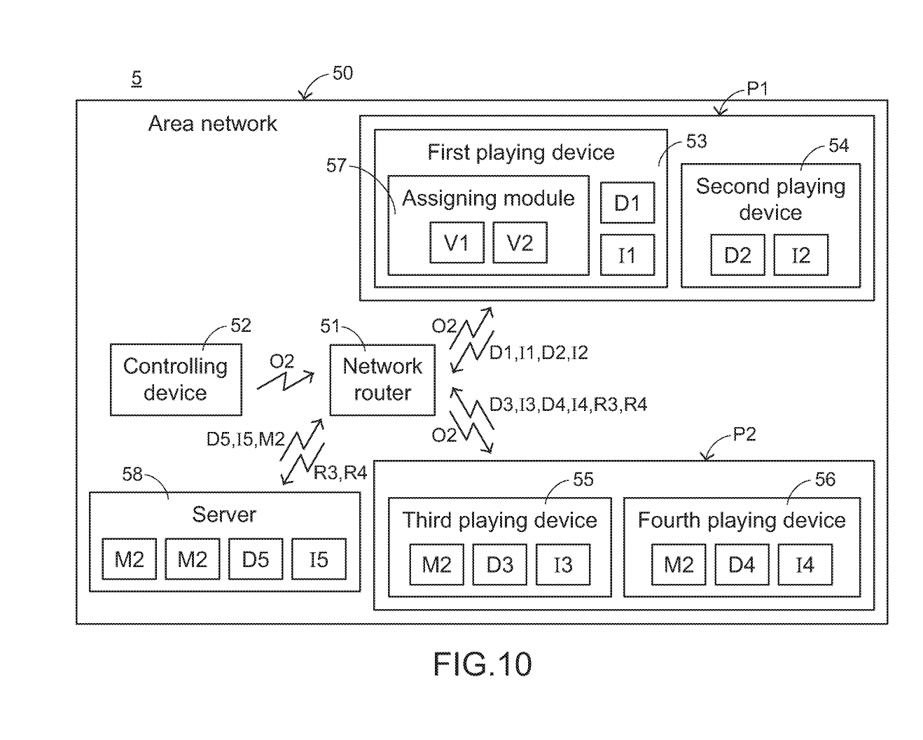

The present invention further provides a media playing system of a second embodiment. FIG. 10 is a schematic functional block diagram illustrating a media playing system according to a second embodiment of the present invention. As shown in FIG. 10, the media playing system 5 comprises a network router 51, a controlling device 52, a first playing device 53, a second playing device 54, a third playing device 55, a fourth playing device 56, an assigning module 57, and a server 58. The first playing device 53 and the second playing device 54 are assigned to a first group P1, and the third playing device 55 and the fourth playing device 56 are assigned to a second group P2. The assigning module 57 is included in the first playing device 53. In addition, the assigning module 57 creates a first virtual device V1 corresponding to the first group P1 and creates a second virtual device V2 corresponding to the second group P2. The first playing device 53 has a first device data D1 and a first communication address data I1. The second playing device 54 has a second device data D2 and a second communication address data I2. The third playing device 55 has a third device data D3 and a third communication address data I3. The fourth playing device 56 has a fourth device data D4 and a fourth communication address data I4. The server 58 has a fifth device data D5 and a fifth communication address data I5. Moreover, the network router 51, the controlling device 52, the first playing device 53, the second playing device 54, the third playing device 55, the fourth playing device 56 and the server 58 are collaboratively defined as an area network 50.

Except for the following three items, the configurations of the media playing system 5 of this embodiment are substantially identical to those of the media playing system 4 of the first embodiment, and are not redundantly described herein. Firstly, the controlling device 52 is a digital media controller and does not have the function of storing media files. Secondly, the server 58 is connected to the network router 51 through network connection, and the first media file M1 and the second media file M2 are stored in the server 58. Thirdly, the assigning module 57 is included in the first playing device 53, not the third playing device.

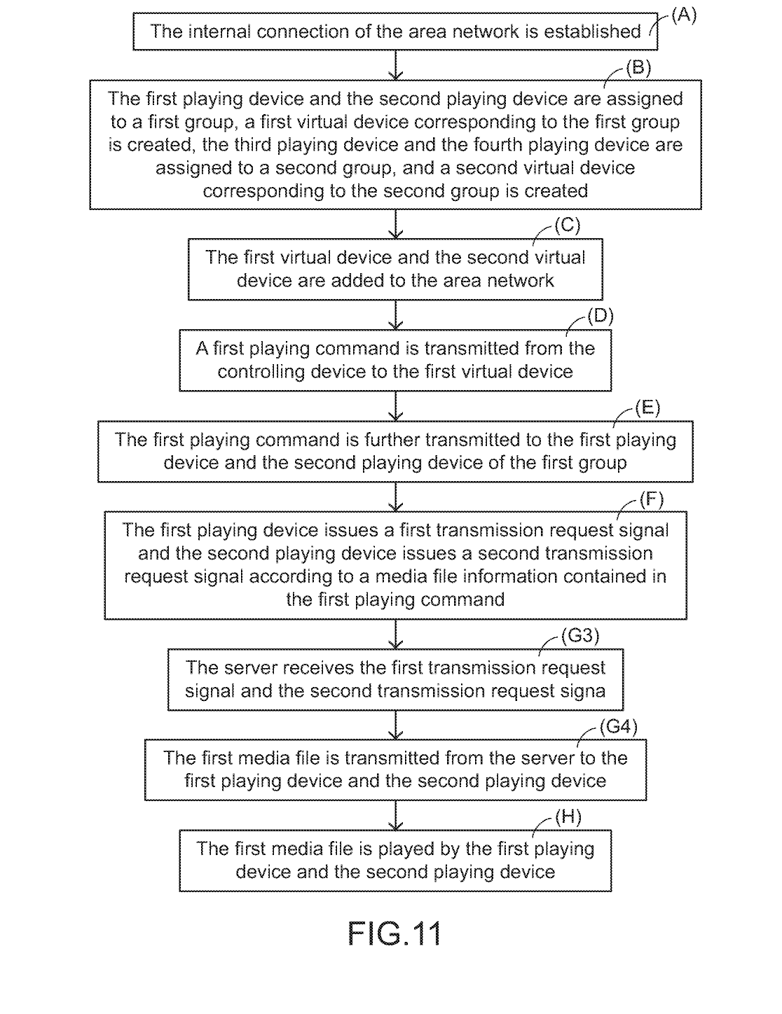

Hereinafter, a media playing method for playing a media file in an area network according to a second embodiment of the present invention will be illustrated with reference to FIG. 11. FIG. 11 is a flowchart illustrating a media playing method for playing a media file in an area network according to a second embodiment of the present invention.

The media playing method comprises the following steps. In the step (A), the internal connection of the area network is established. In the step (B), the first playing device and the second playing device are assigned to a first group, a first virtual device corresponding to the first group is created, the third playing device and the fourth playing device are assigned to a second group, and a second virtual device corresponding to the second group is created. In the step (C), the first virtual device and the second virtual device are added to the area network. In the step (D), a first playing command is transmitted from the controlling device to the first virtual device. In the step (E), the first playing command is further transmitted to the first playing device and the second playing device of the first group. In the step (F), the first playing device issues a first transmission request signal and the second playing device issues a second transmission request signal according to a media file information contained in the first playing command. In the step (G3), the first transmission request signal and the second transmission request signal are received by the server. In the step (G4), the first media file is transmitted from the server to the first playing device and the second playing device. In the step (H), the first media file is played by the first playing device and the second playing device.

Except for the following two items, the operations of the media playing method of this embodiment are substantially identical to those of the media playing method of the first embodiment, and are not redundantly described herein. Firstly, the detailed procedure of the step (A) is distinguished. Secondly, the detailed procedures of the step (G3) and the (G4) are distinguished.

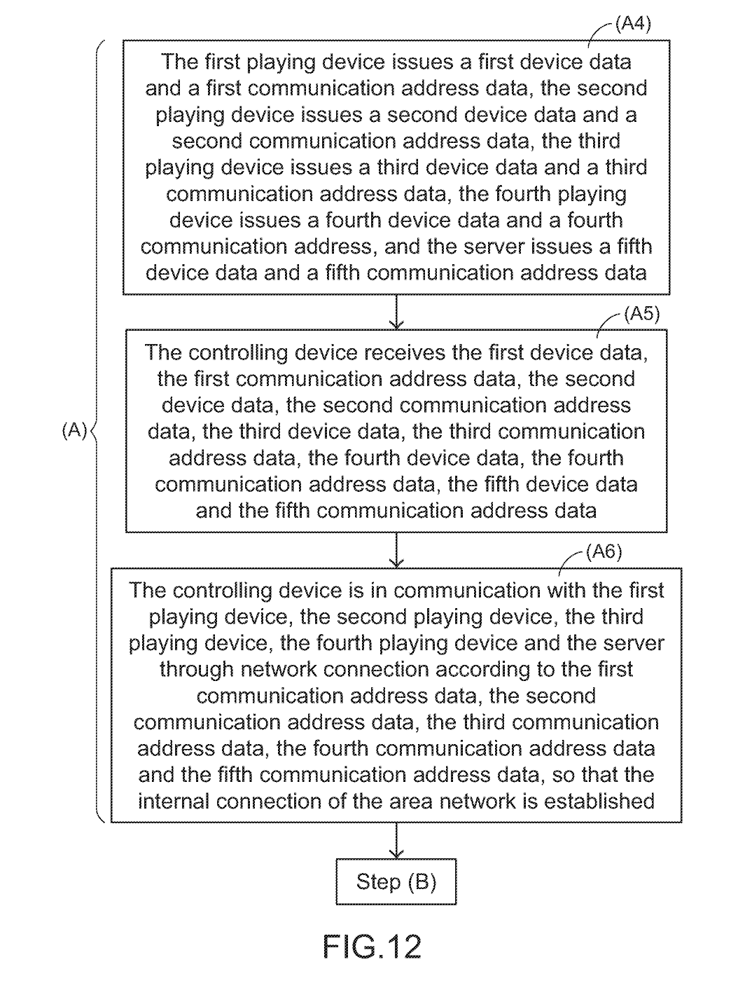

Hereinafter, the detailed procedure of the step (A) performed by the media playing system 5 will be illustrated with reference to FIGS. 10 and 12. FIG. 12 is a flowchart illustrating the step (A) of the media playing method according to the second embodiment of the present invention. The step (A) comprises the following sub-steps. In the sub-step (A4), the first playing device issues a first device data and a first communication address, the second playing device issues a second device data and a second communication address, the third playing device issues a third device data and a third communication address, the fourth playing device issues a fourth device data and a fourth communication address data, and the server issues a fifth device data and a fifth communication address data. In the sub-step (A5), the controlling device receives the first device data, the first communication address data, the second device data, the second communication address data, the third device data, the third communication address data, the fourth device data, the fourth communication address data, the fifth device data and the fifth communication address data. In the sub-step (A6), the controlling device is in communication with the first playing device, the second playing device, the third playing device, the fourth playing device and the server through network connection according to the first communication address data, the second communication address data, the third communication address data, the fourth communication address data and the fifth communication address data, so that the internal connection of the area network is established.

The operations of the media playing system 5 will be illustrated with reference to FIGS. 10 and 11. After the steps (A), (B) and (C) are performed, if the user wants to use the third playing device 55 and the fourth playing device 56 to play the second media file M2 in order to allow the second media file M2 to be listened by the users at different locations, the user may operate the controlling device 52 to select the second media file M2 that is stored in the server 58. Then, the user may select the second virtual device V2 corresponding to the second group P2. Consequently, a second playing command O2 is transmitted from the controlling device 52 to the second virtual device V2. The second playing command O2 contains a second media file information corresponding to the second media file M2. Moreover, the second playing command O2 is firstly transmitted to the first playing device 53 with the assigning module 57, and then transmitted to the third playing device 55 and the fourth playing device 56. Meanwhile, the step (D) and the step (E) are performed.

After the second playing command O2 is received by the third playing device 55, the third playing device 55 realizes that the second media file M2 is stored in the server 58 according to the second media file information. Consequently, the third playing device 55 issues a third transmission request signal R3 to the server 58. On the other hand, after the second playing command O2 is received by the fourth playing device 56, the fourth playing device 56 issues a fourth transmission request signal R4 to the server 58 according to the second media file information. Meanwhile, the step (F) is performed.

In the step (G3), the third transmission request signal R3 from the third playing device 55 and the fourth transmission request signal R4 from the fourth playing device 56 are received by the server 58. In response to the third transmission request signal R3 and the fourth transmission request signal R4, the second media file M2 is transmitted from the server 58 to the third playing device 55 and the fourth playing device 56 (i.e. the step G4). After the second media file M2 is received by the third playing device 55, the second media file M2 is played by the third playing device 55. In addition, after the second media file M2 is received by the fourth playing device 56, the second media file M2 is played by the fourth playing device 56. Meanwhile, the step (H) is performed.

From the above descriptions, the present invention provides a media playing system and a media playing method for playing a media file in an area network. First of all, plural playing devices are assigned to a specified group, and a virtual device corresponding to the specified group is created. When the user wants to simultaneously use the plural playing devices to play the media file, the user may simply control the virtual device to play the media file. Consequently, the media file is played by the plural playing devices corresponding to the specified group. Since the media playing method of the present invention is capable of controlling plural playing devices to play the media file by using only a single manual setting procedure, the process of controlling playback of the playing devices is simplified.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A media playing method for operating a controlling device of an area group to control a first playing device and a second playing device of the area network to play a media file, the media playing method comprising steps of:
(A) establishing internal connection of the area network;
(B) assigning the first playing device and the second playing device to a first group and creating a first virtual device corresponding to the first group;
(C) adding the first virtual device to the area network;
(D) transmitting a first playing command from the controlling device to the first virtual device; and
(E) transmitting the first playing command to the first playing device and the second playing device of the first group.

2. The media playing method according to claim 1, wherein the step (A) comprises sub-steps of:
(A1) issuing a first device data and a first communication address data from the first playing device, and issuing a second device data and a second communication address data from the second playing device;
(A2) the controlling device receiving the first device data, the first communication address data, the second device data and the second communication address data; and
(A3) the controlling device being in communication with the first playing device and the second playing device through network connection, so that the internal connection of the area network is established.

3. The media playing method according to claim 1, wherein the first playing command contains a media file information, wherein after the step (E), the media playing method further comprises steps of:
(F) issuing a first transmission request signal from the first playing device and issuing a second transmission request signal from the second playing device according to the media file information;
(G) transmitting the media file to the first playing device and the second playing device according to the first transmission request signal and the second transmission request signal, respectively; and
(H) playing the first media by the first playing device and the second playing device.

4. The media playing method according to claim 3, wherein the step (G) comprises sub-steps of:
(G1) the controlling device receiving the first transmission request signal and the second transmission request signal; and
(G2) transmitting the first media file from the controlling device to the first playing device and the second playing device.

5. The media playing method according to claim 3, wherein the step (G) comprises sub-steps of:
(G3) a server of the network area receiving the first transmission request signal and the second transmission request signal; and
(G4) transmitting the first media file from the server to the first playing device and the second playing device.

6. The media playing method according to claim 5, wherein the step (A) comprises sub-steps of:
(A4) issuing a first device data and a first communication address data from the first playing device, issuing a second device data and a second communication address data from the second playing device, and issuing a third device data and a third communication address data from the server;
(A5) the controlling device receiving the first device data, the first communication address data, the second device data, the second communication address data, third device data and the third communication address data; and
(A6) the controlling device being in communication with the first playing device, the second playing device and the server through network connection, so that the internal connection of the area network is established.

7. The media playing method according to claim 1, wherein the step (C) comprises sub-steps of:
(C1) issuing a virtual device data and a virtual communication address data from the first virtual device;
(C2) the controlling device receiving the virtual device data and the virtual communication address data; and
(C3) the controlling device being in communication with the first virtual device through network connection, so that the first virtual device is added to the area network.

8. The media playing method according to claim 1, wherein the step (B) further comprises a sub-step of assigning a third playing device and a fourth playing device of the area network to a second group and creating a second virtual device corresponding to the second group, the step (C) further comprises a sub-step of adding the second virtual device to the area network, the step (D) further comprises a sub-step of transmitting a second playing command from the controlling device to the second virtual device, and the step (E) further comprises a sub-step of transmitting the second playing command to the third playing device and the fourth playing device of the second group.

9. A media playing system, comprising:
a network router providing a network connection function;
a controlling device connected to the network router through network connection and issuing a first playing command;
a first playing device connected to the controlling device through network connection via the network router and playing a media file in response to the first playing command;
a second playing device connected to the controlling device through network connection via the network router and playing the media file in response to the first playing command, wherein the controlling device, the first playing device and the second playing device are collaboratively defined as an area network; and
an assigning module assigning the first playing device and the second playing device to a first group, and creating a first virtual device corresponding to the first group, so that the first virtual device is added to the area network, wherein after the first playing command is transmitted from the controlling device to the first virtual device, the first playing command is received by the first playing device and the second playing device of the first group, so that the media file is played by the first playing device and the second playing device.

10. The media playing system according to claim 9, wherein the media file is stored in the controlling device, and the first playing command contains a media file information corresponding to the controlling device, wherein after the media file information is received by the first playing device and the second playing device, the first playing device issues a first transmission request signal to the controlling device according to the media file information and the second playing device issues a second transmission request signal to the controlling device according to the media file information, wherein the media file is transmitted from the controlling device to the first playing device according to the first transmission request signal and the media file is transmitted from the controlling device to the second playing device according to the second transmission request signal, so that the media file is played by the first playing device and the second playing device, wherein the controlling device is a digital media player.

11. The media playing system according to claim 9, wherein the area network further comprises a server, wherein the server is connected to the controlling device through network via the network router, and the media file is outputted from the server in response to the first playing command, wherein the first playing command contains a media file information corresponding to the server, wherein after the media file information is received by the first playing device and the second playing device, the first playing device issues a first transmission request signal to the server according to the media file information and the second playing device issues a second transmission request signal to the server according to the media file information, wherein the media file is transmitted from the server to the first playing device according to the first transmission request signal and the media file is transmitted from the server to the second playing device according to the second transmission request signal, so that the media file is played by the first playing device and the second playing device, wherein the controlling device is a digital media controller.

12. The media playing system according to claim 9, wherein the assigning module comprises an assigning interface, wherein the assigning interface creates the first group in response to a group creating command, and the assigning interface assigns the first playing device and the second playing device to the first group in response to a first device selection command corresponding to the first playing device and a second device selection command corresponding to the second playing device.

13. The media playing system according to claim 9, wherein the assigning module is included in the network router, the controlling unit, the first playing device, the second playing device or a server of the area network.

14. The media playing system according to claim 9, wherein the area network further comprises:
a third playing device connected to the controlling device through network connection via the network router and playing the media file in response to a second playing command; and
a fourth playing device connected to the controlling device through network connection via the network router and playing the media file in response to the second playing command, wherein the assigning module further assigns the first playing device and the second playing device to a second group and creates a second virtual device corresponding to the second group, so that the second virtual device is added to the area network.
